(19) United States
(12) Patent Application Publication
(10) Pub. No.: US 2006/0060293 A1
(43) Pub. Date: Mar. 23, 2006

(54) Produce labeling apparatus and method

(76) Inventor: Alan Constantine, Norwich (GB)

Correspondence Address: Bruce H. Johnsonbaugh;Eckhoff & Hoppe, 333 Sacramento Street, San Francisco, CA, 94111, US

(21) Appl. No.: 11/227,723

(22) Filed: Sep. 14, 2005

Related U.S. Application Data
(60) Provisional application No. 60/611,598, filed on Sep. 20, 2004.

(51) Int. Cl. B65C 9/18

(52) U.S. Cl. 156/247; 156/249; 156/542

(57) ABSTRACT

An apparatus and method are provided for automatically applying labels to produce. Adhesive labels are carried on a split, two part carrier strip along an axis of motion to a stripper edge and are stripped and thereafter applied by a rotary bellows applicator to the produce. The labels are thin and flexible adhesive labels and are momentarily bent about their axis of motion as they approach the stripper edge and the labels are returned to a planar unbent configuration immediately after they are stripped. The invention allows the rotary bellows applicator to be oriented in a much wider variety of configurations relative to the label carrier strip. The invention also provides a significantly narrower stripping plate for use in automatic labeling machines.

### CROSS-REFERENCE TO RELATED APPLICATION

This application claims the benefit of and priority from U.S. provisional application Ser. No. 60/611,598 filed on Sep. 20, 2004.

### BACKGROUND AND BRIEF SUMMARY OF INVENTION

The present invention relates generally to an automatic produce labeling method and apparatus. More specifically, the invention provides a novel automatic labeling method and apparatus for use with thin, plastic self-adhesive labels carried on a split, two part backing tape (or carrier strip) and which is free of design constraints inherent in prior art devices.

The use of adhesive, coded labels on produce has become commonplace. The labels contain “price look up” (PLU) information in human or machine readable form. Such labels are most easily applied to large, firm produce items such as apples. The labels are typically applied to produce by a bellows after having been “stripped” from an elongated carrier strip. Typical prior art labels for use on apples, for example, are relatively thick and stiff and may be stripped by a knife edge.

As the demand for labeling smaller and softer produce grew, the prior art developed thinner, more flexible labels and apparatus for applying those labels. The closest such prior art known to the applicant is shown in LaMers U.S. Pat. Nos. 4,217,164; 4,303,461 and 4,648,930.

Although the LaMers prior art apparatus has been successful in applying thin, flexible labels to relatively soft, small produce, the LaMers design has inherent limitations overcome by the present invention. First, the LaMers design requires that the bellows (or other mechanism) which collects the stripped labels must travel in substantially the same direction at a similar speed to the carrier strip and transferring label, i.e., the carrier strip must be oriented to approach a rotary bellows applicator tangentially. This condition is a consequence of the notched stripper (see FIG. 1, item 24) and places constraints on the geometry of the design, including imposition of minimum overall size and space requirements for the apparatus. Secondly, the LaMers design inherently requires the use of a relatively wide stripping plate, which imposes additional design constraints.

There is a definite need for an automatic labeling apparatus and method capable of applying thin, flexible, self-adhesive labels which are not burdened with the aforementioned constraints of the LaMers design.

The present invention has solved the aforementioned problems. The simplicity of the solution is surprising, given the enormity of the demand. The solution is to simply momentarily bend each label slightly about its axis of motion into a generally V-shaped configuration as it approaches the stripper edge. The solution is analogous to a child bending a flat piece of paper to make a paper airplane. The slight bending of the label (and the bending of paper to make a paper airplane) greatly increases the stiffness of the label along its axis of motion (so, too, with the paper airplane). This solution allows a relatively thin and flexible label to be momentarily bent and to momentarily behave as a much thicker and stiffer label as it is about to be stripped and as it is stripped from its split, two part backing tape or carrier. Immediately after being stripped, the label is quickly returned to a planar (or unbent) configuration wherein it is highly flexible. Since the label is behaving momentarily as a much thicker label as it is stripped, an unnotched and narrow stripper with a stripper edge perpendicular to the axis of motion of the labels is usable for the first time with relatively thin flexible labels which in turn eliminates the prior art design constraint that the carrier plate be positioned tangentially to the surface of the rotary bellows applicator! The solution afforded by the present invention also substantially reduces the width of the stripping plate. The present invention allows reduction in size of the labeling apparatus and allows for variations of system configuration. For example, multiple cassettes may now be usable with thin, flexible labels for the first time at a single labeling station in a labeling system using a rotary bellows applicator.

The prior art also includes a label dispenser (see the Wright U.S. Pat. No. 4,059,203) having a transversely curved dispense edge for stiffening the dispensed labels as they are stripped. Wright utilizes a single strip backing tape, which requires the use of dual curvature on the stripper edge. The dual curvature includes one curvature about an axis perpendicular to the axis of motion of the labels and a second curvature about an axis parallel to the axis of motion of the labels. In contrast, the present invention uses a single bend line about the axis of motion of the labels to form a generally V-shaped stripping edge. The V-shaped stripping edge is straight (whereas in Wright it is curved) and perpendicular to the axis of motion of the labels. The present invention uses a split, two part backing tape wherein each of the two parts runs against one of the two sides of the V-shaped guide plate. The tension in each of the parts of the two part backing tape is thereby kept uniform across the width of the tape. Wright uses the complex dual curvatures of the stripper edge to equalize tension across the width of his single carrier strip. Furthermore, Wright does not teach or suggest varying the angle of the label strip and guide plate relative to the surface onto which the stripped label is transferred.

A primary object of the invention is to provide an automatic labeling apparatus wherein the orientation of the bellows relative to the guide plate for labels is not limited to the tangential relationship of the LaMers prior art design.

A further object is to provide a stripping plate for use in manual or automatic labeling machines, which is significantly narrower than those of the prior art.

Other objects and advantages will become apparent from the following description and drawings, wherein:

### BRIEF DESCRIPTION OF THE DRAWINGS

FIG. 1 is a drawing reproduced from LaMers U.S. Pat. No. 4,217,164 and illustrates the prior art;

FIG. 2 is a section on the line 2-2 of FIG. 1;

FIG. 3 shows a perspective view of the improved guide plate of a labeler incorporating the present invention;

FIG. 4 shows a front view of the improved guide plate of FIG. 3;

FIG. 5 shows a cross-sectional side view of FIG. 4 taken through the line 5-5;

FIG. 6 is a schematic representation of a prior art labeling machine showing the guide plate 22 tangential to the upper surface 8 of bellows 9; and

FIG. 7 is a schematic representation of the present invention showing how the guide plate and the axis of motion of the labels may be oriented at an angle X to the upper surface 8 of bellows 9.

### DETAILED DESCRIPTION OF THE DRAWINGS

The improvement of this invention is principally concerned with the guide plate of such produce labelers and the orientation of the guide plate relative to the bellows, and therefore the other parts of such produce labelers will not be described in detail in this application.

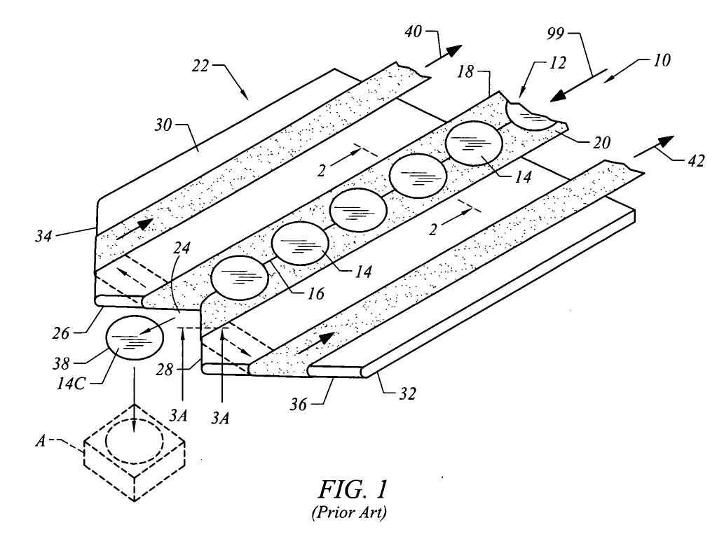

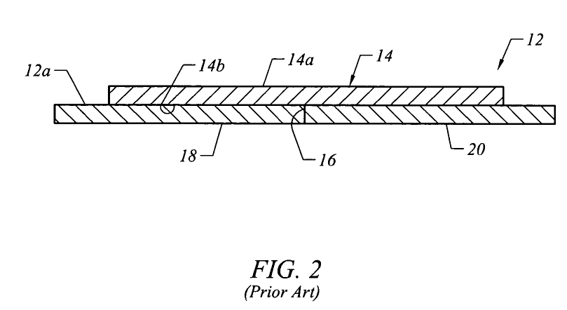

FIGS. 1 and 2 illustrate a portion of a typical prior art labeling system. FIGS. 1 and 2 are reproduced from LaMers U.S. Pat. Nos. 4,217,164; 4,303,461 and 4,648,930, all of which are incorporated herein by reference.

FIG. 1 shows a carrier strip 12 carrying planar labels 14 toward a “stripper” 24. The labels 14 are moving along the direction or axis shown by arrow 99. At the notched “stripper” 24, the two carrier strip portions 18 and 20 are drawn around stripper edges (or separator edges) 26 and 28. The planar labels are separated from the dual carrier strips 18, 20, as shown by label 14c. The “notched” stripper 24, formed by edges 26 and 28, requires that the stripper plate 22 be oriented tangentially to the upper surface 8 of rotary bellows 9, as shown schematically in FIG. 6.

FIG. 2 is a sectional view showing prior art label 14 as it is approaching the stripper. The direction or axis of motion of label 14 in FIG. 2 is perpendicular to the plane of FIG. 2 and directed upwardly toward the viewer. The label 14 and split, two part carrier strip are planar or flat.

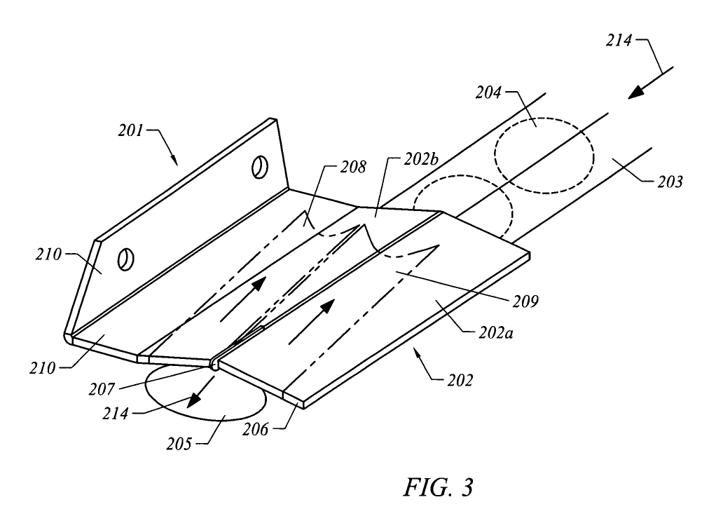

FIG. 3 shows a produce labeler portion 201 incorporating a guide plate according to the present invention generally referenced 202. A two-part split style backing tape or carrier strip 203 carrying a number of labels such as those referenced 204 and 205, respectively, is folded around the guide plate. The guide plate has, at its lower extremity, a stripping edge 206 around which the tape is pulled causing it to be effectively folded back on itself. Stripping edge 206 is unnotched when compared to LaMers. Stripping edge 206 is square to or perpendicular to the axis of motion of the labels, and is essentially a straight edge bent upwardly at its center. As the tape or carrier 203 is pulled around the front edge of the guide plate 202, the label 204, 205 continues to move in a forward direction shown by arrows 214, i.e. the label 205 remains substantially square to the run of the tape 203 and the label's forward motion follows the direction of travel of the tape 203 before having reached the stripping edge 206. Arrows 214 also indicate the “axis of motion” of labels 204, 205.

The underneath of the guide plate which is, in this embodiment, the region preceding the stripping edge 206, has a surface which is bent across the run of the tape (and across the axis of motion of the labels) and, because of the way the tape is strung around the edge, must encounter the underside of the plate as or before the tape reaches the edge. Each of the backing tape halves 208 and 209 runs on sides 202a and 202b of guide plate 202. In this configuration, the bent surface is essentially triangular or V-shaped in cross-section with an apex angle of preferably approximately 160°. At this angle, advantageous separation occurs because the label 205 is forced or bent about its axis of motion into a shallow ‘V’ formation, thus momentarily imparting sufficient stiffness into the label 205 along its axis of motion to cause it to separate from the carrier as the carrier reverses direction at the stripping edge 206. As presented in FIG. 3, the top surface of the labels would be the adhesive side of the labels.

A fin 207 is provided as a centering guide and separates the backing tape halves 208 and 209 from each other. Fin 207 is located in close proximity to the edge 206, and is preferably formed as an integral part of the guide plate 202. The fin 207 centers the split line between strips 208 and 209, causing each strip to run on opposite sides 202a and 202b of the V-shaped guide plate 206, thereby centering the labels as well. Fin 207 assures that the labels are bent in their middle to maximize the momentary stiffness of each label as it is stripped.

On the far side of the guide plate 202 shown in FIG. 3, a spacer 210 is provided which extends essentially parallel to the top surface of the guide plate and along one of the lateral edges in order to allow the guide plate to be fixed into a produce labeler. A spacer is commonly used in such circumstances to provide operational clearance and may take a number of forms. Such a spacer may also be attached to either side 202a, 202b of the guide plate 202.

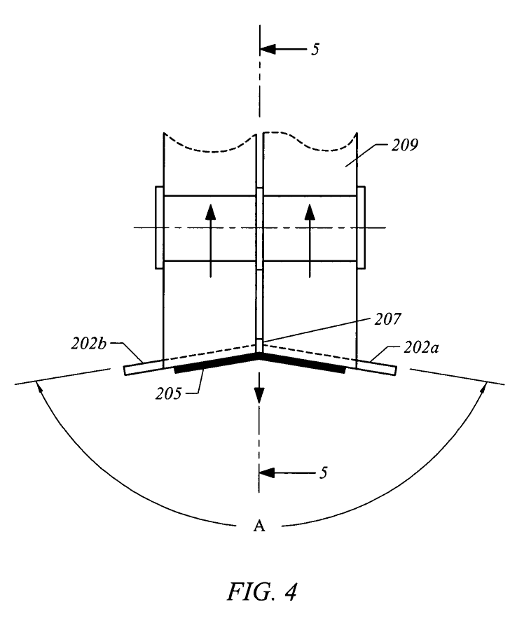

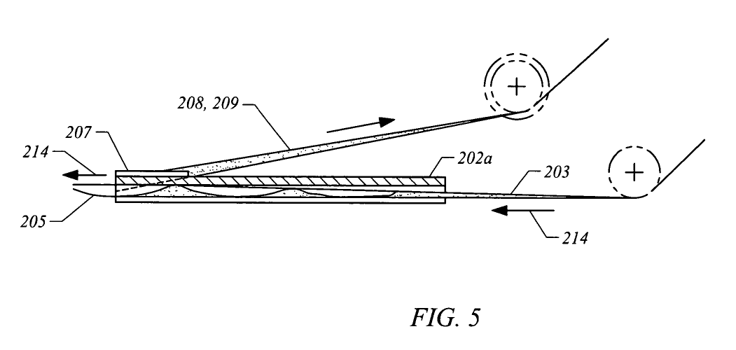

FIGS. 4 and 5 show the guide plate in profile, FIG. 4 from the front edge showing a bend or an apex angle A of approximately 160°. The apex angle is ideally quite shallow, preferably about 160°, preferably in the range of 150°-170°. The angle A can range from 90°-175°, but angles outside the range of 150°-170° are less preferable. As the carrier strip 203 is taken up and over the forward edge of the guide plate it can clearly be seen that the carrier strip 203 is maintained in two parallel halves 208,209 each side of the fin 207 and each half continues in a parallel path whilst the label 205 maintains a substantially square relationship to the guide plate and separates from the carrier strip without following the separate halves.

Looking at FIG. 5 and the side profile of the guide plate in use, one can see this more clearly. The carrier strip 203 comes in from the right with the labels on the underside of the carrier strip 203. As the carrier strip is drawn over the guide plate its two halves follow a similar path away from the guide plate 202. Meanwhile, the label 205 continues in the same direction of travel, shown by arrows 214, and separates from the carrier strip 203 with the adhesive side uppermost as the carrier strip 203 travels around the stripping edge 206 of the guide plate 202. At the point where the label is to detach from the carrier strip 203, means such as rotary bellows (known in themselves) are provided to collect the label 205 and attach it to the end product. As the label passes stripping edge 206 and separates from carrier strip 203, the separation from the unnotched, perpendicular stripping edge 206 causes each label to return to a planar or unbent configuration immediately; in that configuration, it is very flexible. It may be transferred to or collected by the upper surface of a rotary bellows applicator oriented radially (as opposed to tangentially) relative to the guide plate 202.

FIG. 6 is a schematic illustration showing how the prior art guide plate 22 and axis of motion of labels such as 14 must be aligned tangentially with respect to the upper surface 8 of bellows 9.

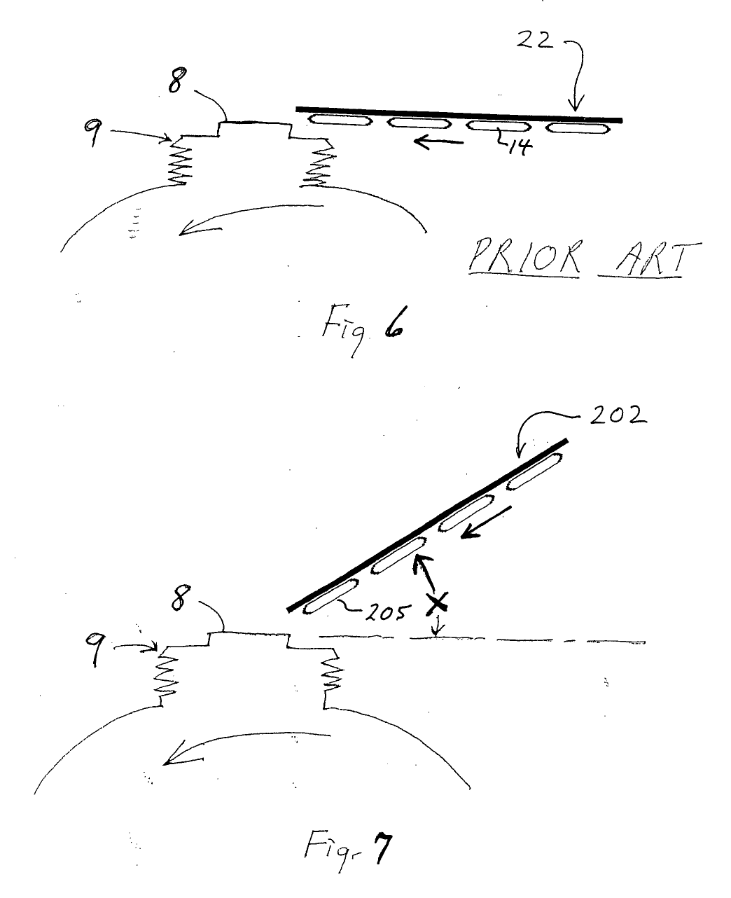

FIG. 7 is a schematic representation of the present invention showing how guide plate 202 and the axis of motion of labels such as 205 forms an angle X with respect to upper surface 8 of bellows 9. Angle X may range from 0° to 45°.

Whilst the above description has focused on produce labelers used in large volume factory labeling, the invention also envisages the use of the improved guide plate on hand-held automated produce labelers and other types of product labeling.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. In a method for automatically applying labels to produce, wherein adhesive labels carried on a split, two part carrier strip move along an axis of motion to a stripper edge, are stripped from said carrier strip, transferred to the upper surface of a rotary bellows and thereafter applied by said bellows to the produce, the improvement comprising the steps:
momentarily bending each of said labels about said axis of motion of said labels having an angle of between approximately 90° and 175° as said labels approach said stripper edge,
stripping said labels from said split, two part carrier strip while said labels are momentarily bent, and
causing said bent label to immediately return to a planar, unbent configuration after said labels are stripped,
whereby said axis of motion forms an angle X relative to said upper surface of said bellows, where X may be between 0° and 90°.

2. The method of claim 1 wherein said labels are momentarily bent to a V-shape having an angle of between approximately 150° and 170°.

3. The method of claim 1 wherein said labels return to a planar, unbent configuration before being transferred to said bellows.

4. Apparatus for automatically applying labels to produce, wherein adhesive labels carried on a split, two part carrier strip move along an axis of motion along a guide plate to a stripper edge, are stripped from said carrier strip and are transferred to the upper surface of a rotating bellows and thereafter applied by bellows to the produce, comprising:
guide plate means having a generally V-shape for momentarily bending each of said labels about said axis of motion of said labels as said labels approach said stripper edge,
means for stripping said labels from said split, two part carrier strip while said labels are momentarily bent, and
means for immediately returning said labels to a planar, unbent configuration after said labels are stripped and prior to said labels being transferred to said upper surface of said bellows,
whereby said guide plate means may be oriented at an angle of between 0° and 90° to said upper surface of said bellows.

5. The apparatus of claim 4 wherein said V-shape forms an angle of between 150° and 170°.

6. The apparatus of claim 4 wherein said stripper edge is unnotched and perpendicular to the axis of motion of said labels.

7. The apparatus of claim 4 wherein the two halves of the split, two part carrier strip move away from said stripper edge in parallel paths.

8. The apparatus of claim 7 further comprising a fin for centering the split line between the two halves of said carrier strip.

9. The apparatus of claim 8 wherein said fin is carried by said guide plate in close proximity to said stripper edge.
